(19) United States
(12) Patent Application Publication
(10) Pub. No.: US 2022/0022687 A1
(43) Pub. Date: Jan. 27, 2022

(54) Cooking Apparatus

(71) Applicant: TCG Partners LLC - Intellectual Property Series, Houston, TX (US)

(72) Inventors: Hunter R. Jaggard, Houston, TX (US); Griffin T. Jaggard, Houston, TX (US); Stephen P. Dunn, Houston, TX (US)

(21) Appl. No.: 17/383,330

(22) Filed: Jul. 22, 2021

Related U.S. Application Data
(60) Provisional application No. 63/055,191, filed on Jul. 22, 2020.

(51) Int. Cl. A47J 36/34

(52) U.S. Cl. CPC A47J 36/34

(57) ABSTRACT

A collapsible platform assembly, method of assembly, and method of packaging is provided for herein. The platform assembly includes a first and second stand portion, which are connectable to one another to form a stand. One or more legs can be connected to the stand portions to provide a desired height to the stand. A cooking surface can be maintained by one or more arms extending from the stand portions. The assembly can be packaged in an compact container to provide advantages in shipping costs and logistics.

### BACKGROUND OF INVENTION

### Field of the Invention

This invention relates to a cooking apparatus and specifically to a platform supporting a cook surface.

### SUMMARY OF THE INVENTION

This disclosure provides a cooking apparatus providing collapsibility and improved usability. The cooking apparatus includes one or more interlocking stand portions which, when coupled to one another provide a stand capable of securing a cook surface.

One aspect of the disclosure provides a stand assembly for securing a cook surface, providing resistance to collapse of the platform on uneven and tilted ground surfaces. The stand's ability to rest on uneven and/or titled surfaces provides safety to the user and other bystanders in the event the cooking apparatus is knocked.

Another aspect of the disclosure provides a means for retaining a removable cook surface. The removal of the cook surface allows for quick and easy cleaning of the cook surface and overall collapsibility of the cooking apparatus when not in use.

Another aspect of the disclosure provides disassembly of the body members for compact packaging. Compact packaging greatly improves shipping of the product by allowing more products to be shipped in a single load container, reducing the cost of shipping overall.

### BRIEF DESCRIPTION OF THE SEVERAL VIEWS OF THE DRAWING(S)

The accompanying drawings illustrate various exemplary implementations and are part of the specification. The illustrated implementations are proffered for purpose of example, not for purpose of limitation.

FIG. 1 depicts a perspective view of a disassembled cooking apparatus, as shown and described herein.

FIG. 2 depicts a perspective view of an assembled cooking apparatus, as shown and described herein.

FIG. 3a depicts a side view of a retaining arm, as shown and described herein.

FIG. 3b depicts a side view of a retaining arm engaging a cook surface, as shown and described herein.

FIG. 4 depicts a close-up view of a leg assembly, as shown and described herein.

FIG. 5 depicts a first side view of the cooking apparatus, as shown and described herein.

FIG. 6 depicts a second side view of the cooking apparatus, as shown and described herein.

### DETAILED DESCRIPTION OF THE INVENTION

It will be understood that, although the terms first, second, third, etc. may be used herein to describe various elements, these elements should not be limited by these terms. These terms are only used to distinguish one element from another element. Thus, a first element discussed below could be termed a second element without departing from the teachings of the present disclosure.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, steps, operations, elements, components, and/or groups thereof.

The disclosed cooking apparatus includes a stand having one or more stand portions and a cook surface. Each stand portion can include one or more framing components forming a body member, one or more retaining arms, one or more legs, or any combination thereof. In one or more embodiments, the stand can be maneuvered between an assembled embodiment and a disassembled embodiment, the assembled embodiment providing a structure for maintaining and using the cook surface. One or more retaining arms can extend from a body member, the retaining arms configured to engage the cook surface. One or more removable legs can extend downward from the body member to provide height and stability to the stand. The cooking apparatus disclosed herein is particularly suited for supporting a cook surface having a rounded bottom surface, similar to a wok, but is suitable for cook surfaces of several shapes and sizes.

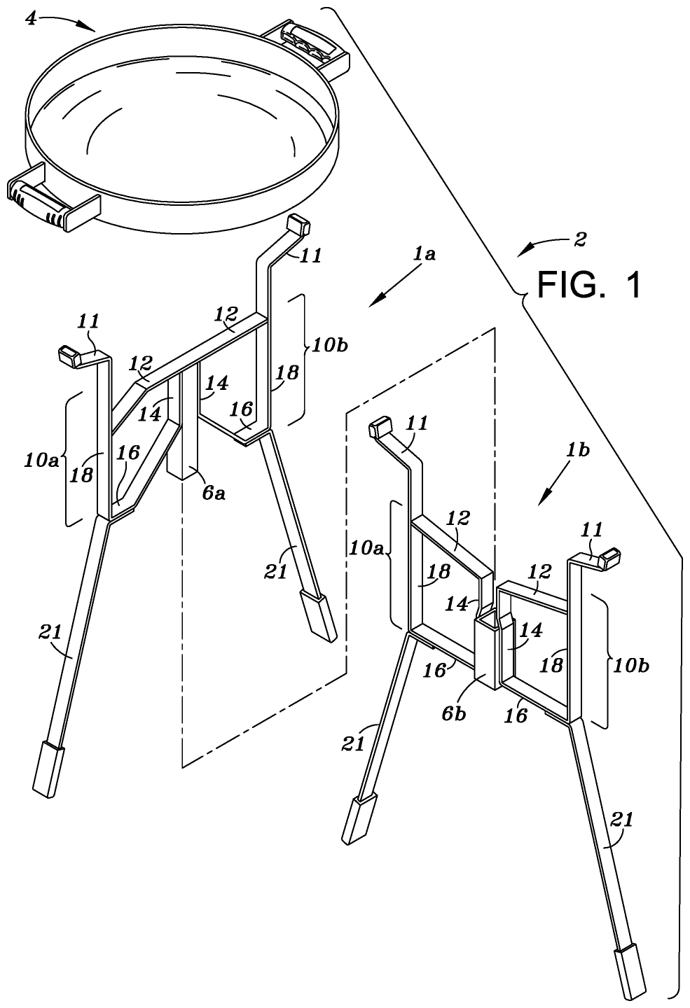

FIG. 1 depicts a perspective view of a disassembled cooking apparatus 2, including a first stand portion 1a, a second stand portion 1b, and a cook surface 4. Each stand portion 1 can include one or more body members 10a-b. As shown, the two body members 10a-b are coupled to one another about a central member 6a-b which, when assembled, forms a central axis of the cooking apparatus 2. The body member 10a-b can include one or more frame components, including a top frame member 12, an inner frame member 14, a lower frame member 16, and an outer frame member 18, or any combination thereof, the combination of which forms a frame. Each stand portion 1a-b can include one or more central members 6a-b (two are shown), which can define a central connection point for the body members 10a-b of the respective stand portion 1a-b. The outer frame member 18, or another segment connected to the body member 10, can extend upward from the body member 10, and a retaining arm 11 can extend from a top end of the outer frame member 18. One or more legs 21 can be removably coupled to one or more of the body members 10a-b. As shown, a leg 21 can be connected by one or more connectors to the lower frame member 16 about a body connection surface.

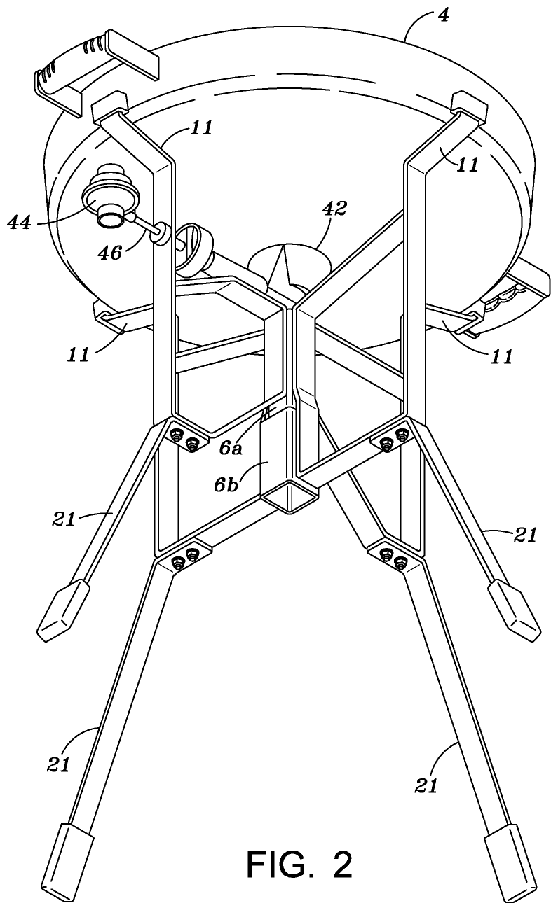

FIG. 2 depicts a perspective view of the assembled cooking apparatus 2. When used herein, the terms “horizontal” and “vertical” are used to provide direction and plane of frame components and, in doing so, refer to the stand portions and/or cooking apparatus as it is in an assembled embodiment set on the ground. The central member 6a of the first stand portion 1a can be coupled to the central member 6b of the second stand portion 1b. The coupling of the central members 6a-b can be accomplished by one of several embodiments such that the configuration will connect, or otherwise couple, the frame portions 1a-b to one another to form the assembled stand. As shown, the first and second central members 6a, 6b can be or include tubular members where the first central member 6a is configured to partially insert into the second central member 6b whereby the outer surface of the first central member 6a engages or abuts the inner surface of the second central member 6b. This male/female receptacle configuration allows the user to assemble/disassemble the stand by raising and lowering one stand portion in relation to the other stand portion. The non-circular shape of the connectors 6a-b prevent the stand portions 1a-b from rotating in relation to one another when assembled. The cooking apparatus can be disassembled by removing the cook surface 4 and uncoupling the stand portions 1a-b.

A burner assembly 40 can be coupled to the stand such that the flame produced by a burner 42 provides heat to the cook surface 4. A flame burner 42 can be coupled to one of the top frame members 12 such that the flame provides heat to the cook surface 4 about a central position. The burner assembly 40 can include the burner 42, a regulator 44, and an extension hose 46. The extension hose 46 can connect the regulator 44 to the burner 42 and securing the burner assembly 40 to the stand by coupling to one of the outer frame members 18.

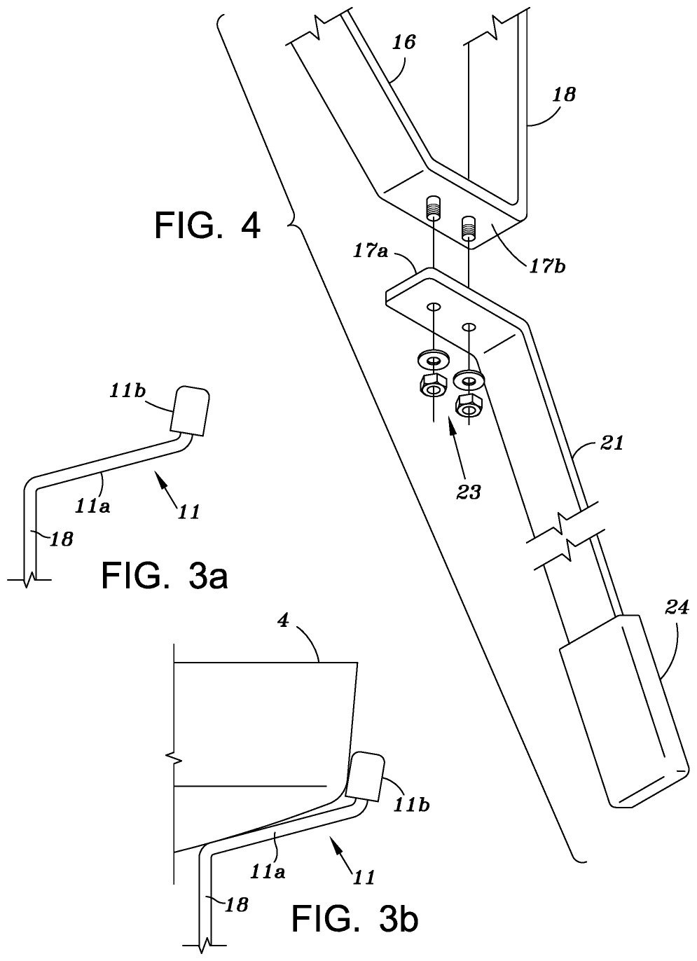

In the assembled configuration of the cooking apparatus 1, the retaining arms 11 provide four bottom contact surfaces for the cook surface 4 and four possible side contact surfaces for the cook surface 4. The side contact surfaces provide the necessary retaining means in the event the stand and/or cook surface sustain vertical force. Without the retaining arms, as disclosed, generally vertical force might otherwise cause the cook surface 4 to become dislodged and dangerously depart from the stand altogether. FIG. 3a depicts a close-up view of a retaining arm 11 and FIG. 3b depicts a side view of the retaining arm 11 engaging the cook surface 4. The retaining arm 11 can extend from the outer frame member at a preferred angle, providing a means for securing the cook surface 4 in a preferred position. For example, the retaining arm can be a section of the outer frame member. The retaining arm 11 can extend in a general horizontal direction in relation to the a generally vertical outer frame member. The first portion 11a of the retaining arm 11 can extend from the longitudinal axis of the outer frame member at about 73 degrees. The second portion 11b of the retaining arm 11 can extend from the longitudinal axis of the first portion 11a of the retaining arm 11 at about 86 degrees. In this embodiment, the first and second portions 11a, 11b extend in an upward direction.

In an embodiment, the retaining arm 11 can include a first portion 11a that extends from the longitudinal axis of the outer frame member at an angle between about 45 degrees to about 90 degrees. In another embodiment, the first portion 11a of the retaining arm can extend from the longitudinal axis of the outer frame member at an angle between about 0 degrees and 180 degrees. In another embodiment, the first portion 11a of the retaining arm 11 can extend from the longitudinal axis of the outer frame member at an angle between about 45 degrees and about 80 degrees. In another embodiment, the first portion 11a of the retaining arm 11 can extend from the longitudinal axis of the outer frame member at an angle between about 45 degrees and about 80 degrees.

The retaining arm 11 can include a second portion 11b that extends from the first portion 11a at a preferred angle and/or in a preferred direction. For example, the second portion 11b can extend from the longitudinal axis of the first portion 11a at an angle between about 0 degrees and about 90 degrees. In another embodiment, the second portion 11b can extend from the longitudinal axis of the first portion 11a at an angle between about 10 degrees and about 90 degrees. In another embodiment, the second portion 11b can extend from the longitudinal axis of the first portion 11a at an angle between about 0 degrees and about 90 degrees. In another embodiment, the second portion 11b can extend from the longitudinal axis of the first portion 11a at an angle between about 10 degrees and about 50 degrees. In another embodiment, the second portion 11b can extend from the longitudinal axis of the first portion 11a at an angle of or about 45 degrees.

One or more portions of each retaining arm 11 can include a length of material, which can include flattened or shaped metal (including steel, iron, aluminum) and/or plastic (including heavy polymers). Any section of the retaining arm can include a coating, wrap, or attachment made of a plastic, rubber, or rubber like material to provide friction (a “friction material”) with the cook surface 4. The friction material will help to prevent the undesired movement of the cook surface 4 as it rests on the stand. As shown in a first example, the second portion 1b of the retaining arm 11 can include a friction material of a tip or cap about its terminal end. In another embodiment, the entire retaining arm can include a friction material.

The retaining arm 11 can include a portion (as shown, first portion 11a) that is generally horizontal for the purpose of engaging the bottom surface of the cook surface 4. As such, the cooking apparatus, at least in part, relies on gravity to maintain the cooking surface 4 on the stand. The retaining arms 11 can also include a portion (as shown, second portion 11b) that is generally vertical. The vertical portion can, but does not necessarily, engage a bottom or outer surface of the cook surface 4. The vertical portion can function as a catch or stop to the horizontal movement of the cook surface, which is especially beneficial when the cook surface and/or stand is knocked in a horizontal (or generally horizontal) direction.

Commonly, the retaining arms 11 and their extension from the corresponding outer frame member 18 are the same as one another in size, shape, and appearance to provide uniformity and easy use of the cooking apparatus. However, in other embodiments, the retaining arms 11 may differ from one another.

During use, the cook surface becomes hot, posing a threat of harm to any bystander if the cook surface was to be removed (separated, dislodged, disconnected, dislocated, or detached) from the stand. Securing the cook surface is, therefore, a paramount concern for the design of the cooking apparatus. Securing the cook surface can include proving a position for placing the cook surface on the stand so that the cook surface is restricted from lateral and/or horizontal movement during use. When not in use, the cooking apparatus can be disassembled or can remain in the assembled configuration. For disassembly, The retaining arms are positioned such that a user can lift the cook surface in an upward direction such that the cook surface is no longer resting on the generally horizontal portion of the a retaining arm and is no longer in contact with or within the confines of the generally vertical portion of the retaining arms.

Referring to FIG. 4, each leg 21 is removably connected to a bottom portion of the body member 10a-b. As shown, the leg 21 can include an elongated portion extending downward, providing height to the stand. The length of the leg 21 can be manufactured to any desired length such that the overall stand provides a desirable height of the cook surface 4 for the user. In one or more embodiments, the legs can be extendable.

At or about a top end of the leg 21 can extend a connection surface 17a configured to attached to the body member 10a-b about a corresponding connection surface 17b. As shown, the connection surface 17a can include a generally flat portion extending from the elongated portion at a desired angle, providing an overlapping of or abutting to connection surface 17b of the body member 10. One or more connection means can connect/couple the leg 21 to the body member 10. Connection means can include one or more bolts and nuts 23 (as shown), interlocking slide engagement, welding such as tac welding, clamps or presses, and other appropriate connectors.

The removability of each elongated leg 21 provides significant benefit to the seller of the cooking apparatus 2. Shipping from manufacturer to end user of any product comes at a cost, and reduction of that costs increases profits for the seller. In an embodiment where the legs are not removable, the container for a single cooking apparatus 2 would be relatively large to accommodate the length of the frame portion 1 to the length of the legs 21. The removable legs 21 allow for the cooking apparatus to be fitted into a smaller container, wherein the legs 21 can be positioned in the container such that they are not extending outward from the body members 10, greatly reducing the required volume of the container. The smaller container results in more units shipped in a shipping container or truck and more units able to be displayed on store shelves.

At or about the bottom end of each leg can extend a foot section, or a foot 24. The foot 24 can include a cover over a bottom length of the leg 21, where the cover can be a slip-on piece or a coating applied directly to the leg 21 to provide the foot 24. The purpose of the foot includes protecting the lower end of the leg 21 from scratches, dents, and other deformations caused by sliding, hitting, dropping, kicking, or anything likely to damages the lower ends of the legs. The feet 24 can be made of a plastic, plastic-like, rubber, or rubber-like material. Each foot 24 can be replaceable, where the foot material can slide on and off the bottom end of the leg 21 to be replaced. The foot may also be or include a coating material that is sprayed or pressed onto the bottom end of the leg 21.

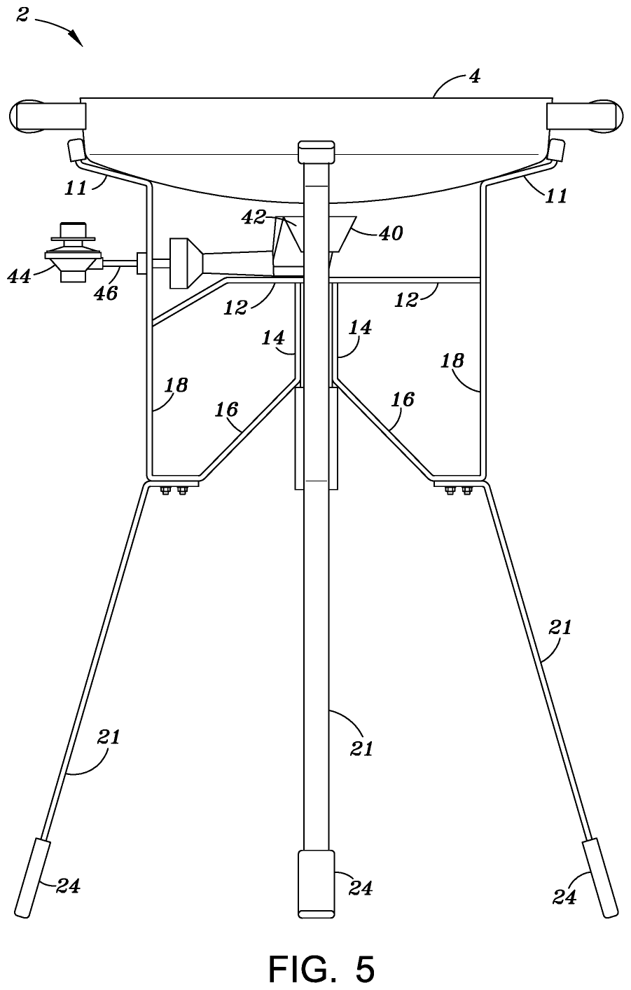

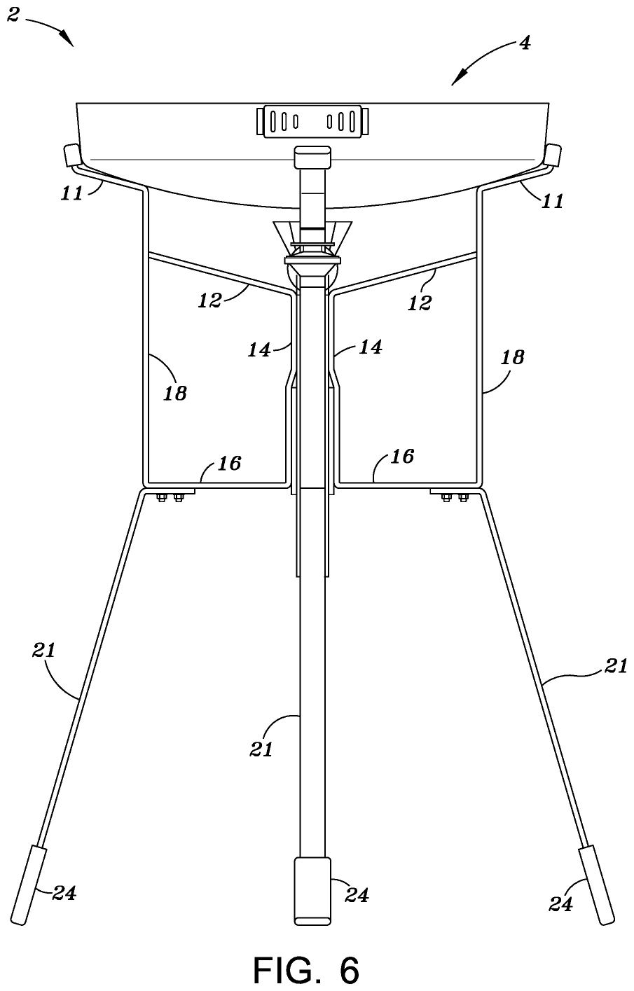

FIG. 5 depicts a first side view of the assembled cooking apparatus 2 and FIG. 6 depicts a second side view of the assembled cooking apparatus 2. The frame members 12, 14, 16, 18 provide structure and support to the cooking apparatus. In embodiments, one or more of the frame members 12, 14, 16, 18 can be modified and can otherwise differ from one stand portion 1 to the other. For example, the lower frame member of the first stand portion 1a can include a section that extends at an upward angle from horizontal and has a connection point to the connector 6a and/or inner frame member 12 that is higher than the similar connection point on the second stand portion 1b. This modification allows for the first central member 6a to slide downward into the second central member and provides an obstruction, or stop, for the second central member 6b at a preferred position. In another example, a section of the top frame member 12 can be modified in a downward direction to provide space for the burner apparatus. In another example, any one of the frame members 12, 14, 16, 18 can be or include modifications/bends/directional changes for both aesthetic and/or structural reasons.

At least one embodiment of the cooking apparatus 2 can be configured to be used or set on several types of ground surfaces, including concrete/pavement, dirt, rock, sand, and more. In many circumstances, the ground surface may or not be flat and level. Accordingly, the cooking apparatus 2 can be configured to allow minor adjustments and movements of the stand portions 1a-b in relation to one another such that the cooking surface 4 remains in a safe and upright position. This is primarily accomplished by allowing flexibility or “wiggle room” with the coupling of the connectors 6a-b.

Although the present invention has been described with respect to specific details, it is not intended that such details be regarded as limitations on the scope of the invention. It will thus be appreciated that those skilled in the art will be able to devise numerous alternative arrangements that, while not shown or described herein, embody the principles of the invention and thus are within its spirit and scope.

What is claimed is:

1. A collapsible platform assembly, comprising:
a first stand portion comprising:
a first central member,
a top frame member having a first end connected to a first outer frame member and a second end connected to a second outer frame member,
a first bottom frame member having a first end connected to the first outer frame member and a second end connected to the central member, wherein a first leg is attached to the first bottom frame member via a first connector,
a second bottom frame member having a first end connected to the second outer frame member and a second end connected to the central member, wherein a second leg is attached to the second bottom frame member via a second connector; and
a second stand portion comprising:
a second central member,
a top frame member having a first end connected to a third outer frame member and a second end connected to a fourth outer frame member,
a third bottom frame member having a first end connected to the third outer frame member and a second end connected to the second central member, wherein a third leg is attached to the third bottom frame member via a third connector,
a fourth bottom frame member having a first end connected to the fourth outer frame member and a second end connected to the second central member, wherein a fourth leg is attached to the fourth bottom frame member via a fourth connector.

2. The assembly of claim 1, wherein the legs are adjustable in length.

3. The assembly of claim 1, wherein one or more retaining arms extend upward from each of the first stand portion and the second stand portion and are configured to retain a cook surface.

4. The assembly of claim 1, wherein the legs are removable.

5. The assembly of claim 1, wherein the first and second stand members are electively moved between an assembled embodiment and a disassembled embodiment, the assembled embodiment providing a structure for maintaining and using a cook surface.

6. The assembly of claim 1, wherein one or more of the legs comprises an elongated section and an adjacent connection surface.

7. A collapsible platform assembly, comprising:
a first stand portion comprising a first body member connected to a second body member via a first central member;
a second stand portion comprising a third body member connected to a fourth body member via a second central member;
a first leg configured to attach to the first body member via a first connector;
a second leg configured to attach to the second body member via a second connector;
a third leg configured to attach to the third body member via a third connector; and
a fourth leg configured to attach to the fourth body member via a fourth connector.

8. The assembly of claim 7, wherein each leg connects to a bottom framing member of the respective body member.

9. The assembly of claim 8, wherein the first stand portion and the second stand portion are connected to one another via the first and second central members to provide a stand and wherein the legs are configured to provide additional height to the stand.

10. The assembly of claim 9, wherein the legs are adjustable in length.

11. The assembly of claim 9, wherein a foot is disposed about the bottom end of one or more of the legs.

12. The assembly of claim 8, wherein the connection surface of the leg extends from the elongated portion of the leg at a desired angle.

13. The assembly of claim 7, each leg connects to a lower framing member of the respective body member.

14. A method for packaging a collapsible cooking assembly, comprising:
defining a length and a width of a cook surface;
constructing a first stand portion comprising a first body member and a second body member connected to one another via a central member, wherein the first stand member is planar and wherein the width and height of the stand portion does not exceed the width and height of the cook surface;
constructing a second stand portion comprising a third body member and a fourth body member connected to one another via a central member, wherein the second stand member is planar and wherein the width and height of the stand portion does not exceed the width and height of the cook surface;
constructing one or more legs having a length equaling not more than the hypotenuse of the length and width of the cook surface; and
packing the cook surface, first stand portion, second stand portion, and one or more legs in a lateral position and one top of one another in a container.
